(19) United States
(12) Patent Application Publication
(10) Pub. No.: US 2012/0272924 A1
(43) Pub. Date: Nov. 1, 2012

(54) ANIMAL TRAINING APPARATUS HAVING MULTIPLE RECEIVERS EQUIPPED WITH LIGHT EMITTING UNITS

(76) Inventor: Min Jae SO, Seoul (KR)

(21) Appl. No.: 13/095,169

(22) Filed: Apr. 27, 2011

(51) Int. Cl. A01K 15/02

(52) U.S. Cl. 119/720

(57) ABSTRACT

The present invention relates to an animal training apparatus having multiple receivers equipped with light emitting units. The animal training apparatus is configured such that a single level setting switch and a plurality of receiver selection switches are provided on a transmitter, so that the vibration or shock levels of the receivers are adjusted, thus simplifying the structure of the animal training apparatus and allowing a trainer to easily manipulate the animal training apparatus. Further, three LED units implemented as three LEDs of red, green and blue colors are installed on each of the receivers and emit lights corresponding to a plurality of colors by combining red, green and blue colors, thus enabling the locations of dogs that are being trained to be easily detected when the dogs are trained outdoors in the evening or at night.

### BACKGROUND OF THE INVENTION

1. Field of the Invention

The present invention relates, in general, to an animal training apparatus having multiple receivers equipped with light emitting units, and, more particularly, to an animal training apparatus having multiple receivers equipped with light emitting units, which stores vibration or shock levels, set in a plurality of receivers that are worn on a plurality of dogs, in memory so as to control the vibration or shock levels of the respective receivers using a single transmitter, and applies a vibration or a shock corresponding to a vibration or shock level stored in the memory when a receiver selection switch is pressed, and in which Light Emitting Diode (LED) units are installed on each receiver and emit lights having different colors outdoors in the evening or at night, thus allowing the locations of dogs to be easily detected.

2. Description of the Related Art

Generally, an animal training apparatus is worn on the neck or another part of the body of an animal and is configured to apply an electric shock or a vibration to the animal, thus training the animal. The level of the electric shock or vibration applied by such an animal training apparatus is adjusted by controlling a level control switch attached to the transmitter of the animal training apparatus.

As shown in FIG. 1A, the animal training apparatus includes a transmitter 1 and a receiver 2. The transmitter 1 transmits a Radio Frequency (RF) signal 3 so that an electrical stimulation is applied to an animal according to the manipulation of a trainer who trains the animal.

The transmitter 1 includes a level control switch 4, a transmission switch 5, and a transmitting antenna 6. The level control switch 4 sets the level of a shock wave to be output from the receiver 2. The transmission switch 5 receives a signal so that a signal required to transmit the RF signal 3, which includes the level of the shock wave set by the level control switch 4, is output. The transmitting antenna 6 transmits an RF signal which includes both information indicative of the shock wave level and Identification (ID) code information required to determine a relevant receiver according to the level set by the level control switch 4.

Such a conventional animal training apparatus includes only a single receiver for a single transmitter. Accordingly, there is the inconvenience in that when a single trainer intends to simultaneously train a plurality of animals, the same number of transmitters and receivers as the number of animals to be trained are required, and in that transmitters corresponding to receivers worn on the respective animals must be used whenever individual animals are trained.

An animal training apparatus having multiple receivers to solve this inconvenience is shown in FIG. 1B and is configured such that in order to control the vibration or shock levels of a plurality of receivers using a single transmitter, a plurality of level setting switches 7-1, 7-2, . . . , 7-6 and a plurality of receiver selection switches 8-1, 8-2, . . . , 8-6 are provided on the transmitter. Further, such an animal training apparatus can perform control such that a specific level setting switch (for example, 7-1) corresponding to the receiver worn on the neck of a specific dog is manipulated to adjust the level of a vibration or an electric shock that is applied to the specific dog, and a receiver selection switch 8-1 corresponding to the level setting switch 7-1 is manipulated to transmit the adjusted vibration or electric shock level.

However, the conventional animal training apparatus having multiple receivers is operated such that the levels of vibrations or electric shocks of respective receivers are stored in internal memory and such that when a receiver selection switch corresponding to a receiver worn on a specific dog is pressed, a relevant vibration or electric shock level stored in the internal memory is read and is then transmitted to the receiver.

Therefore, such a conventional animal training apparatus is problematic in that a plurality of level setting switches and a plurality of receiver selection switches corresponding to a plurality of receivers are provided, so that the structure of the apparatus is complicated, and a trainer who manipulates the apparatus also experiences difficulty when manipulating the level setting switches and the receiver selection switches.

Further, when a plurality of dogs are trained outdoors in the evening when the sun sets, it is difficult to detect the locations of the dogs that wear receivers in a dark place and it is impossible to grasp the situation in which the receivers are operated at a distance.

Therefore, there is a need to install devices, which are capable of detecting the locations of dogs that are being trained, on the receivers when training the dogs outdoors in the evening or at night.

### SUMMARY OF THE INVENTION

Accordingly, the present invention has been made keeping in mind the above problems occurring in the prior art, and an object of the present invention is to provide an animal training apparatus having multiple receivers equipped with light emitting units for location detection, in which a single level setting switch is provided on a single transmitter, so that the vibration or shock levels of a plurality of receivers can be adjusted.

Another object of the present invention is to provide an animal training apparatus having multiple receivers equipped with light emitting units for location detection, which can detect the locations of dogs that are being trained when training the dogs outdoors in the evening or at night.

In order to accomplish the above objects, the present invention provides an animal training apparatus having multiple receivers equipped with light emitting units, including a transmitter; and a plurality of receivers which are worn on animals that are being trained and vibration or shock levels of which are adjusted by the transmitter, wherein the transmitter includes a plurality of receiver selection switches configured to select a receiver, a vibration or shock level of which is to be set, from among the plurality of receivers and to transmit a signal including the vibration or shock level of the selected receiver; a level setting switch configured to set a vibration or shock level of each of the receivers; a display unit configured to display the vibration or shock level; a memory unit configured to store data about the vibration or shock level set by the level setting switch; a Radio Frequency (RF) transmission unit configured to transmit RF data, which includes the data about the vibration or shock level set by the level setting switch, to the plurality of receivers under control of a transmission control unit; a light emitting mode selection switch configured to select a light emitting mode in which a plurality of Light Emitting Diode (LED) units installed on each of the receivers emit light; and the transmission control unit configured to perform control such that the vibration or shock level currently set by the level setting switch is received and displayed on the display unit and such that when a selection signal is input from a relevant receiver selection switch, a vibration or shock level of a corresponding receiver which is stored in the memory unit is read and displayed on the display unit, and configured to control the RF transmission unit so that a transmission signal including the vibration or shock level read from the memory unit is transmitted to the receiver corresponding to the relevant receiver selection switch, and also configured to perform control such that when the level set by the level setting switch is changed while a selection signal is being input from the relevant receiver selection switch, the changed level is stored in the memory unit.

In accordance with an embodiment of the present invention, when the relevant receiver selection switch is successively pressed twice, the transmission control unit may store the vibration or shock level set by the level setting switch in the memory unit.

In accordance with an embodiment of the present invention, the transmitter may further include a storage switch configured such that when a trainer presses the storage switch and inputs a storage command signal to the transmission control unit, the transmission control unit receives the vibration or shock level set by the level setting switch and stores the received vibration or shock level in the memory unit.

In accordance with an embodiment of the present invention, each of the plurality of receivers may include three LED units.

In accordance with an embodiment of the present invention, when the light emitting mode selection switch is pressed a first time, the three LED units may be set to first mode in which the three LED units are simultaneously turned on and off, when the light emitting mode selection switch is pressed a second time, the three LED units may be set to a second mode in which while first and third LED units of the three LED units are turned on, a second LED unit disposed therebetween is turned off, and in which while the first and third LED units are turned off, the second LED unit is turned on; when the light emitting mode selection switch is pressed a third time, the three LED units may be set to a third mode in which whenever a relevant receiver selection switch of the transmitter is pressed, three LED units of a receiver corresponding to the receiver selection switch are repeatedly and simultaneously turned on and off at high speed; and when the light emitting mode selection switch is pressed a fourth time, the three LED units may be set to a fourth mode in which the three LED units of the relevant receiver are not operated.

### BRIEF DESCRIPTION OF THE DRAWINGS

The above and other objects, features and advantages of the present invention will be more clearly understood from the following detailed description taken in conjunction with the accompanying drawings, in which:

FIG. 1A is a perspective view of a conventional animal training apparatus having a single transmitter and a single receiver:

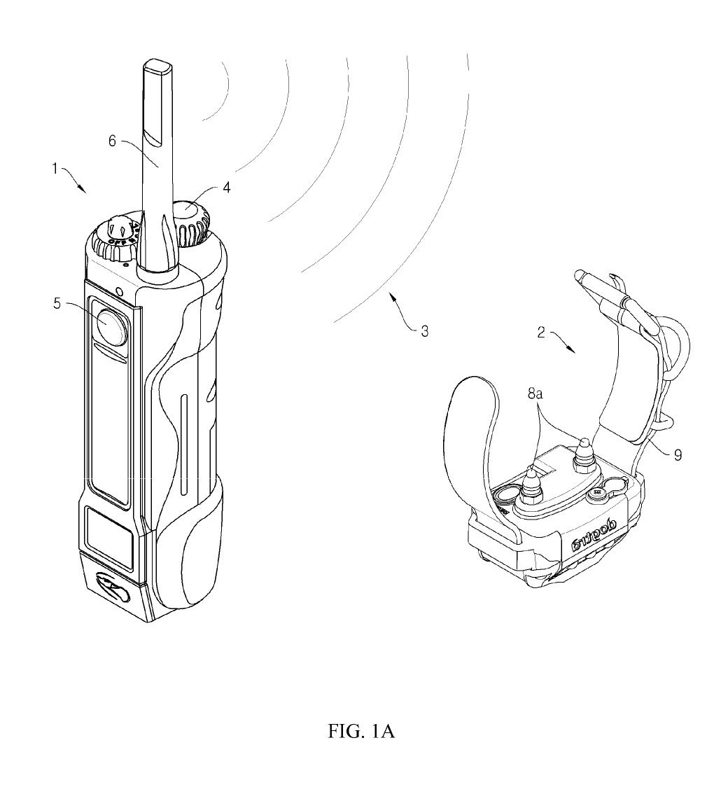

FIG. 1B is a perspective view of a conventional animal training apparatus having a single transmitter and a plurality of receivers;

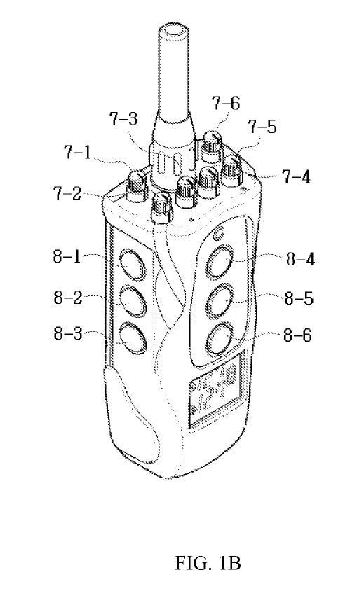

FIG. 2 is a block diagram showing the construction of an animal training apparatus having a single transmitter and a plurality of receivers according to the present invention;

FIG. 3 is a perspective view showing the appearance of the transmitter of an animal training apparatus having a single level setting switch and six receiver selection switches according to the present invention;

FIG. 4 is a block diagram showing the construction of the transmitter according to another embodiment of the present invention;

FIG. 5 is a perspective view of a receiver having three LED units according to the present invention;

FIG. 6 is a perspective view showing a plurality of receivers having LED units and a transmitter having receiver selection switches corresponding to the receivers according to the present invention; and

FIGS. 7A to 7C are diagrams showing the operation modes of LED units installed on each receiver according to the present invention.

### DESCRIPTION OF THE PREFERRED EMBODIMENTS

Hereinafter, embodiments of the present invention to accomplish the above objects will be described in detail with reference to the attached drawings.

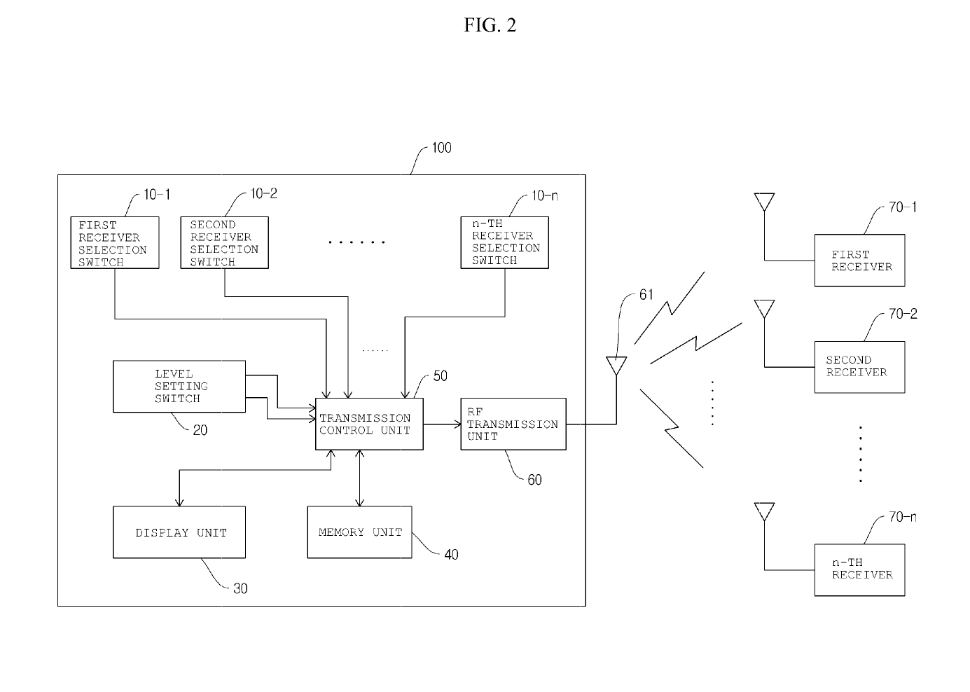

FIG. 2 is a block diagram showing the construction of an animal training apparatus having a single transmitter and a plurality of receivers according to the present invention.

The transmitter 100 of the animal training apparatus according to the present invention includes a plurality of receiver selection switches 10-1, 10-2, . . . , 10-n, a level setting switch 20, a display unit 30, a memory unit 40, a Radio Frequency (RF) transmission unit 60, and a transmission control unit 50. The receiver selection switches 10-1, 10-2, . . . , 10-n are configured to select a relevant receiver, the vibration or shock level of which is to be set, from among a plurality of receivers 70-1, 70-2, . . . , 70-n, and transmit a signal including the vibration or shock level of the relevant receiver. The level setting switch 20 is configured to set the vibration or shock level of each of the receivers 70-1, 70-2, . . . , 70-n. The display unit 30 displays the vibration or shock level. The memory unit 40 stores data about the vibration or shock level set by the level setting switch 20. The RF transmission unit 60 transmits RF data, including the vibration or shock level data set by the level setting switch 20, to a relevant receiver 70 under the control of the transmission control unit 50. The transmission control unit 50 performs control such that the vibration or shock level currently set by the level setting switch 20 is received and is displayed on the display unit 30 and such that when a selection signal is input from a relevant receiver selection switch (for example, 10-1), the vibration or shock level of the relevant receiver (for example, 70-1) stored in the memory unit 40 is read and displayed on the display unit 30. Further, the transmission control unit 50 controls the RF transmission unit 60 so that a transmission signal including the vibration or shock level read from the memory unit 40 is transmitted to the receiver (for example, 70-1) corresponding to the relevant receiver selection switch (for example, 10-1), and performs control such that when the level set by the level setting switch 20 is changed while the selection signal is being input from the receiver selection switch (for example, 10-1), the changed level is stored in the memory unit 40. Further, the animal training apparatus includes the plurality of receivers 70-1, 70-2, . . . , 70-n which are worn on animals that are being trained and the vibration or shock levels of which are adjusted by the transmitter 100.

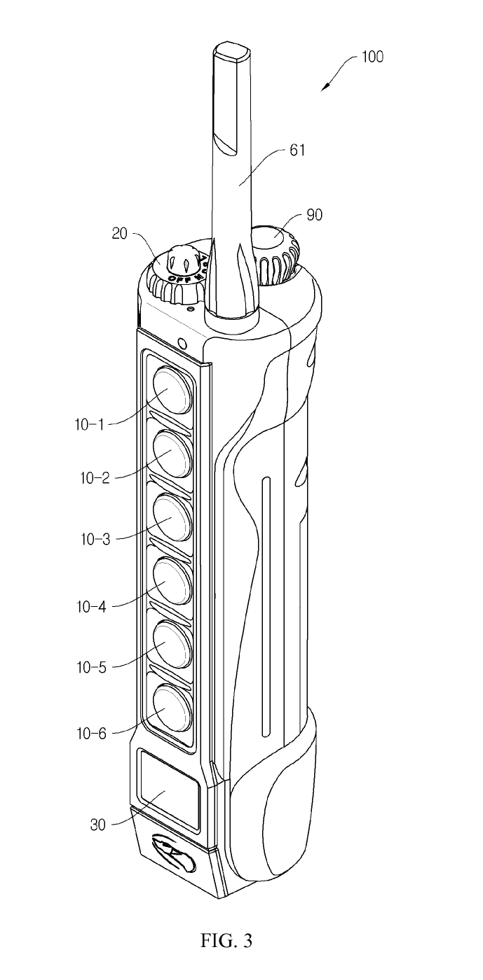

FIG. 3 is a perspective view showing the appearance of the transmitter of an animal training apparatus having a single level setting switch and six receiver selection switches according to the present invention.

In the transmitter 100 of the animal training apparatus according to the present embodiment, the display unit 30 is disposed on a lower portion of the front surface of the transmitter 100, and the six receiver selection switches 10-1, 10-2, . . . , 10-6 required to select a receiver, the vibration or shock level of which is to be set, from among six receivers 70-1, 70-2, . . . , 70-6 are separately displayed on the front surface and the left side surface of the transmitter.

An antenna 61, the level setting switch 20, and a light emitting mode selection switch 90 are disposed on the top surface of the transmitter 100. The antenna 61 radiates an RF signal output from the RF transmission unit 60 into the air. The level setting switch 20 is configured to set the vibration or shock level of a relevant receiver. The light emitting mode selection switch 90 enables the selection of a light emitting mode in which light is emitted from three Light Emitting Diode (LED) units 71, 72 and 73 installed in each of the six receivers 70-1, 70-2, . . . , 70-6.

When a trainer presses the first receiver selection switch 10-1 of the transmitter 100, a first receiver selection signal is input to the transmission control unit 50. The transmission control unit 50 that received the first receiver selection signal reads the vibration or shock level of the first receiver 70-1, which is stored in the memory unit 40, includes it in a transmission signal, and transmits the transmission signal via the RF transmission unit 60.

In this case, the transmission control unit 50 stores data, indicting that the first receiver selection switch 10-1 has been pressed by the trainer, in a flag bit. When the first receiver selection switch 10-1 is pressed once more, the transmission control unit 50 reads the data stored in the flag bit of the first receiver selection switch 10-1. If the read data indicates that the first receiver selection switch 10-1 was previously pressed (that is, if the first receiver selection switch 10-1 was successively pressed twice), the transmission control unit 50 stores the level set by the level setting switch 20 in the memory unit 40. At this time, the vibration or shock level of the first receiver 70-1, which was previously stored in the memory unit 40, is deleted.

When the data stored in the flag bit of the first receiver selection switch 10-1 is not the data indicating that the first receiver selection switch 10-1 was previously pressed, the transmission control unit 50 converts only the flag bit into data indicating that the first receiver selection switch 10-1 has been pressed, stores the data, and does not change the level of the first receiver 70-1 stored in the memory unit 40.

In this way, the vibration or shock levels of the plurality of receivers 70-1, 70-2, . . . , 70-n are set by the single level setting switch 20, and thus the complication of usage and the difficulty of manipulation occurring when a plurality of level setting switches are provided can be solved.

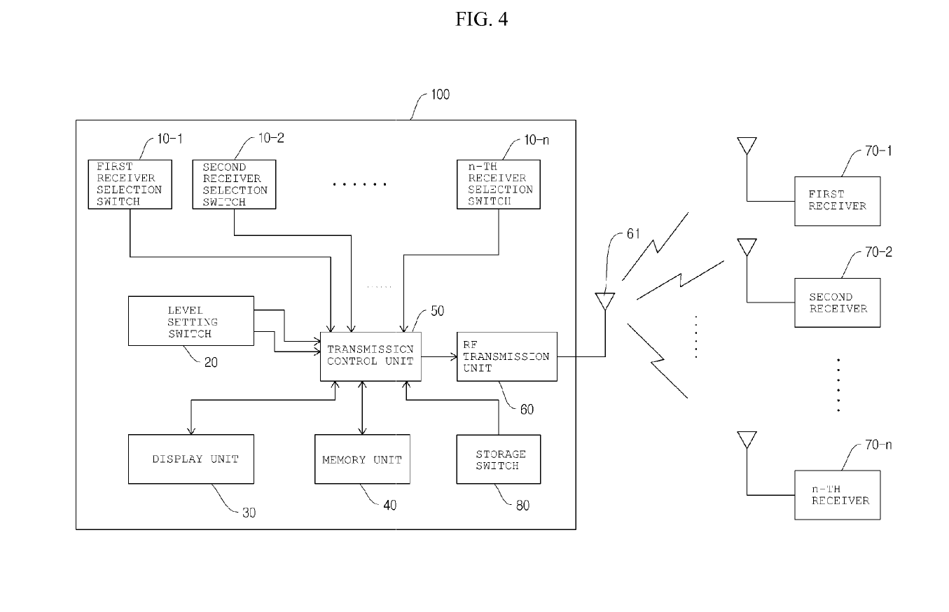

FIG. 4 is a block diagram showing the construction of a transmitter according to another embodiment of the present invention.

The transmitter 100 according to the present embodiment further includes a storage switch 80, so that when a trainer intends to store a vibration or shock level set by the level setting switch 20 in the memory unit 40, if he or she presses the separate storage switch 80 and inputs a storage command signal to the transmission control unit 50, the transmission control unit 50 receives the vibration or shock level set by the level setting switch 20 and stores the vibration or shock level in the memory unit 40.

In the transmitter according to the present embodiment, when any one receiver selection switch (for example, 10-1) is pressed, the vibration or shock level of the receiver 70-1 corresponding to the pressed receiver selection switch (for example, 10-1) is read from the memory unit 40 and is then displayed on the display unit 30.

In this case, the logo of a dog for which the number of the receiver is indicated can be displayed on the display unit 30 in order to indicate the vibration or shock level set for the relevant receiver 70-1.

When a plurality of dogs are trained outdoors in the evening when the sun sets, it is difficult to detect the locations of dogs which wear the plurality of receivers 70-1, 70-2, . . . , 70-n in a dark place, and it is impossible to grasp the situation in which the receivers 70-1, 70-2, . . . , 70-n are operated at a distance.

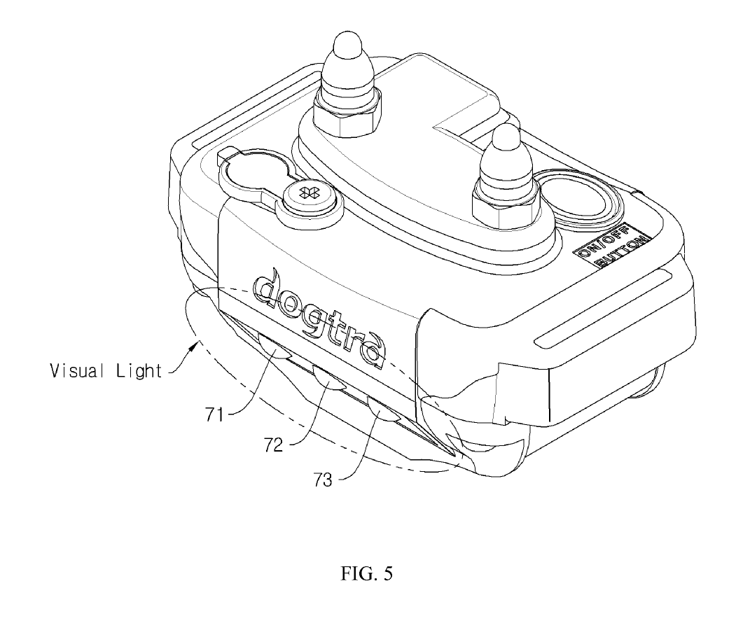

Therefore, in order to detect the locations of the dogs that are being trained when the dogs are trained outdoors in the evening or at night, three LED units, in which red, green and blue LEDs are implemented as respective units, are installed on the front surface of each of the receivers 70-1, 70-2, . . . , 70-n, as shown in FIG. 5.

The reason for installing the three LED units on the front surface of each of the receivers 70-1, 70-2, . . . , 70-n is that three LED units emit more light than do a single LED unit, thus allowing the trainer to more easily detect light emitted from each of the receivers 70-1, 70-2, . . . , 70-n worn on the dogs that are being trained at a distance. Therefore, if necessary, the LED units installed on each of the receivers 70-1, 70-2, . . . , 70-n can also be installed on the left or right side surface of each receiver on which the light emitted from each receiver is not blocked and can be viewed from the outside, as well as the front surface. The number of LED units installed is not limited to 3, and more than three LED units can be installed.

The three LEDs can be simultaneously turned on to emit white light and two of the LEDs can be simultaneously turned on to emit light corresponding to six kinds of colors, so that lights corresponding to seven kinds of colors such as red, green, blue, yellow, violet, orange, and white colors, are allocated to six receivers, and the receivers can emit the lights corresponding thereto, thus enabling the six receivers to be identified using light.

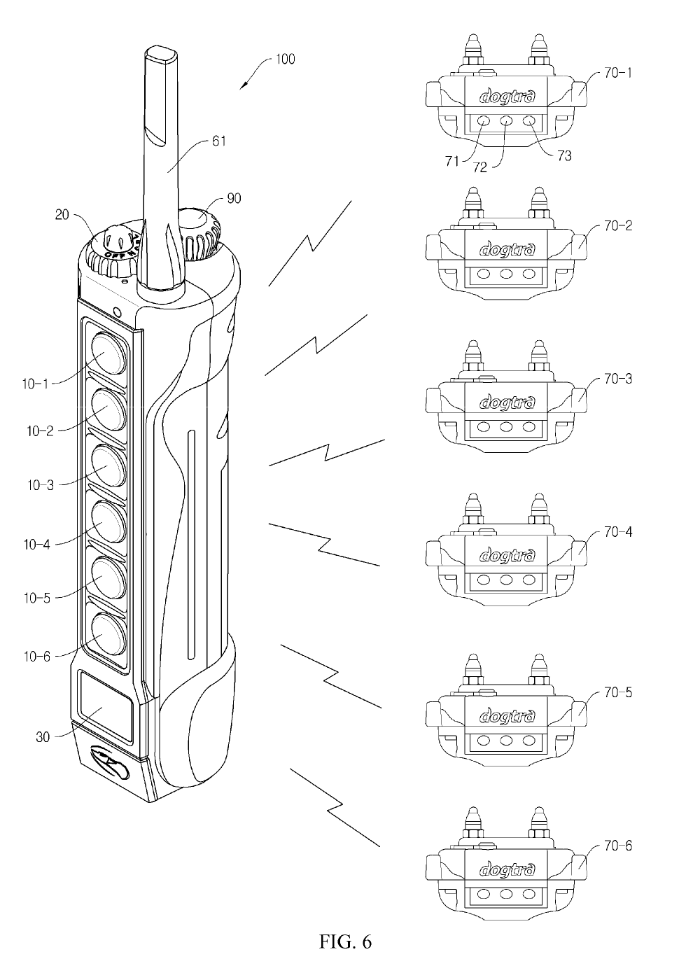

FIG. 6 is a diagram showing a plurality of receivers equipped with LED units and a transmitter having receiver selection switches corresponding to the receivers according to the present invention.

A transmitter 100 according to the present invention is identical to the transmitter described in FIG. 2, and thus a detailed description thereof is omitted. Six receivers 70-1, 70-2, . . . , 70-6 according to the present invention are operated when a trainer individually presses six corresponding receiver selection switches 10-1, 10-2, . . . , 10-6 installed on the transmitter 100.

That is, when the trainer presses the first receiver selection switch 10-1, a vibration or an electric shock at a preset vibration or shock level is applied to the skin of a dog which is wearing the first receiver 70-1.

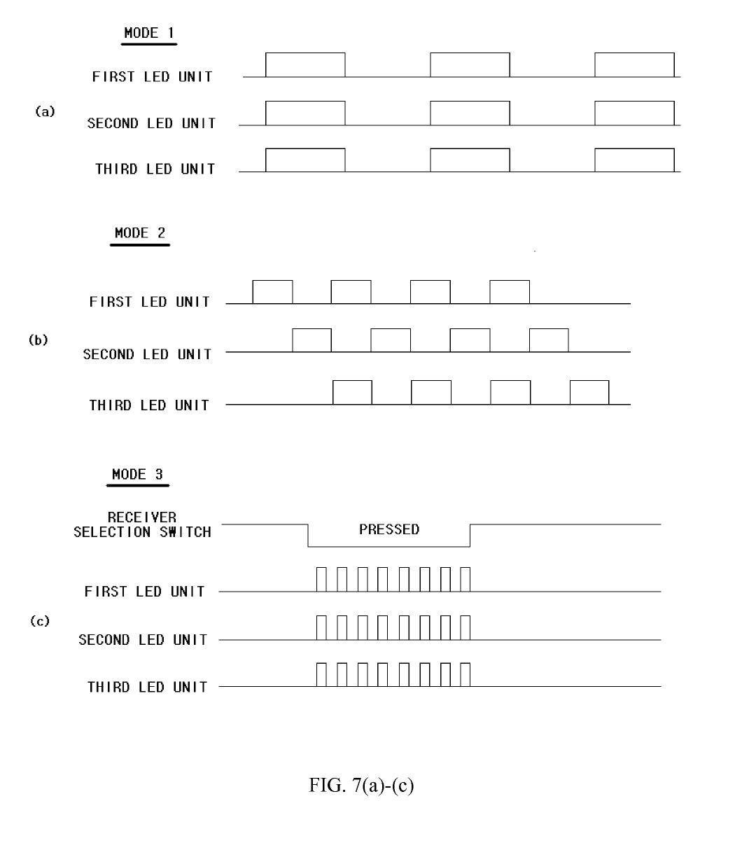

When the trainer presses a light emitting mode selection switch 90 a first time, three LED units 71, 72 and 73 installed on each of the six receivers 70-1, 70-2, . . . , 70-6 are set to a first mode in which the three LED units 71, 72 and 73 are simultaneously turned on and turned off, as shown in FIG. 7A.

When the trainer presses the light emitting mode selection switch 90 a second time, the three LED units 71, 72, and 73 are set to a second mode in which while the first and second LED units 71 and 73 are turned on, the second LED unit 72 disposed therebetween is turned off, and in which while the first and third LED units 71 and 73 are turned off, the second LED unit 72 is turned on, as shown in FIG. 7B.

The operation of the second mode enables lights indicated by the three LED units 71, 72, and 73 to be viewed with the trainer's eyes as if the lights had varied, thus allowing the trainer to more easily find the location of a target dog.

Further, when the trainer presses the light emitting selection switch 90 a third time, the three LED units 71, 72, and 73 are set to a third mode in which whenever the relevant receiver selection switch (for example, 10-1) of the transmitter 100 is pressed, the three LED units 71, 72, and 73 of the receiver 70-1 corresponding to the receiver selection switch 10-1 are repeatedly and simultaneously turned on and off at high speed, as shown in FIG. 7C.

When the trainer presses the light emitting mode selection switch 90 a fourth time, the three LED units 71, 72 and 73 of each receiver are set to a fourth mode in which they are not operated.

Such operations for the above modes correspond to a single embodiment, and various types of modifications are possible in such a way that, for example, the three LED units 71, 72, and 73 are set to a mode in which they are sequentially turned on and off.

According to the present invention, the animal training apparatus is advantageous in that a single level setting switch and a plurality of receiver selection switches are provided on a single transmitter, and the vibration or shock levels of a plurality of receivers are adjusted, and thus the structure of the animal training apparatus can be simplified, and the trainer can easily manipulate the animal training apparatus. Further, the present invention is advantageous in that a plurality of LED units implemented as three LEDs having red, green and blue colors are installed on each receiver and can emit lights corresponding to a plurality of colors by combining red, green and blue colors, thus allowing a trainer to easily detect the locations of dogs that are being trained when the dogs are trained outdoors in the evening or at night.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An animal training apparatus having multiple receivers equipped with light emitting units, comprising:
a transmitter; and
a plurality of receivers which are worn on animals that are being trained and vibration or shock levels of which are adjusted by the transmitter,
wherein the transmitter comprises:
a plurality of receiver selection switches configured to select a receiver, a vibration or shock level of which is to be set, from among the plurality of receivers and to transmit a signal including the vibration or shock level of the selected receiver;
a level setting switch configured to set a vibration or shock level of each of the receivers;
a display unit configured to display the vibration or shock level;
a memory unit configured to store data about the vibration or shock level set by the level setting switch;
a Radio Frequency (RF) transmission unit configured to transmit RF data, which includes the data about the vibration or shock level set by the level setting switch, to the plurality of receivers under control of a transmission control unit;
a light emitting mode selection switch configured to select a light emitting mode in which a plurality of Light Emitting Diode (LED) units installed on each of the receivers emit light; and
the transmission control unit configured to perform control such that the vibration or shock level currently set by the level setting switch is received and displayed on the display unit and such that when a selection signal is input from a relevant receiver selection switch, a vibration or shock level of a corresponding receiver which is stored in the memory unit is read and displayed on the display unit, and configured to control the RF transmission unit so that a transmission signal including the vibration or shock level read from the memory unit is transmitted to the receiver corresponding to the relevant receiver selection switch, and also configured to perform control such that when the level set by the level setting switch is changed while a selection signal is being input from the relevant receiver selection switch, the changed level is stored in the memory unit.

2. The animal training apparatus according to claim 1, wherein when the relevant receiver selection switch is successively pressed twice, the transmission control unit stores the vibration or shock level set by the level setting switch in the memory unit.

3. The animal training apparatus according to claim 1, wherein the transmitter further comprises a storage switch configured such that when a trainer presses the storage switch and inputs a storage command signal to the transmission control unit, the transmission control unit receives the vibration or shock level set by the level setting switch and stores the received vibration or shock level in the memory unit.

4. The animal training apparatus according to claim 1, wherein each of the plurality of receivers comprises three LED units.

5. The animal training apparatus according to claim 4, wherein:
when the light emitting mode selection switch is pressed a first time, the three LED units are set to first mode in which the three LED units are simultaneously turned on and off,
when the light emitting mode selection switch is pressed a second time, the three LED units are set to a second mode in which while first and third LED units of the three LED units are turned on, a second LED unit disposed therebetween is turned off, and in which while the first and third LED units are turned off, the second LED unit is turned on;
when the light emitting mode selection switch is pressed a third time, the three LED units are set to a third mode in which whenever a relevant receiver selection switch of the transmitter is pressed, three LED units of a receiver corresponding to the receiver selection switch are repeatedly and simultaneously turned on and off at high speed; and
when the light emitting mode selection switch is pressed a fourth time, the three LED units are set to a fourth mode in which the three LED units of the relevant receiver are not operated.
